(19) United States
(12) Patent Application Publication
(10) Pub. No.: US 2008/0229750 A1
(43) Pub. Date: Sep. 25, 2008

(54) Location ring arrangement

(75) Inventor: Mark Sipson, Nottingham (GB)

Correspondence Address: OLIFF & BERRIDGE, PLC, P.O. BOX 320850, ALEXANDRIA, VA, 22320-4850, US

(73) Assignee: ROLLS-ROYCE PLC, London (GB)

(21) Appl. No.: 12/071,778

(22) Filed: Feb. 26, 2008

(30) Foreign Application Priority Data
Mar. 22, 2007 (GB) 0705458.8

(51) Int. Cl. F02C 7/22; F23R 3/00

(52) U.S. Cl. 60/734; 60/740; 60/746; 60/752

(57) ABSTRACT

Location rings 3, 23 are generally known to present a sealing ring 2, 12 in combustor parts of a gas turbine engine. The location rings 3, 23 act to present the sealing rings 2, 12 such that fuel spray nozzles are appropriately presented towards the combustor whilst these location rings 3, 23 are more susceptible to wear than a panel 4, 24 within which the arrangement 1, 10 is secured. Previously location rings 3 have been located by dedicated bolts 6 provided in drilled and tapped apertures in the panel 4. Each bolt 6 is typically spot welded to provide a lock feature such that upon repair and overhaul it is necessary to remove a heat shield 5 and then remove the spot welds before disassembly. By integrating the heat shield 25 with location ring 23 portions it is possible to utilize the existing heat shield retainer positions as fixing points 19 with associated rail or strap elements 16, 17 such that through overlap along retainer edges 26, 27 a desired retained configuration is achieved.

The present invention relates to location ring arrangements and more particularly to location ring arrangements utilized with regard to locating fuel spray nozzles within a gas turbine engine.

Operation of gas turbine engines is relatively well known and, as will be appreciated, requires presentation of fuel for combustion in order to generate thrust. In order to present that fuel, a fuel spray nozzle is required which itself is located within a panel such that the fuel spray is appropriately presented within the combustor parts of the gas turbine engine. It will be understood that the combustor parts of a gas turbine engine will generate significant heat and therefore thermal stressing as well as vibration and other factors may create significant wear upon the mountings for the spray nozzle. In such circumstances generally a ring is provided within the panel which ensures that the fuel spray nozzle is appropriately presented with any wear being taken away from the meter panel by a heat shield, or a support to locate the heat shield. In such circumstances, upon repair and overhaul it is generally easier to replace the support or heat shield rather than the entire mounting panel within the gas turbine engine.

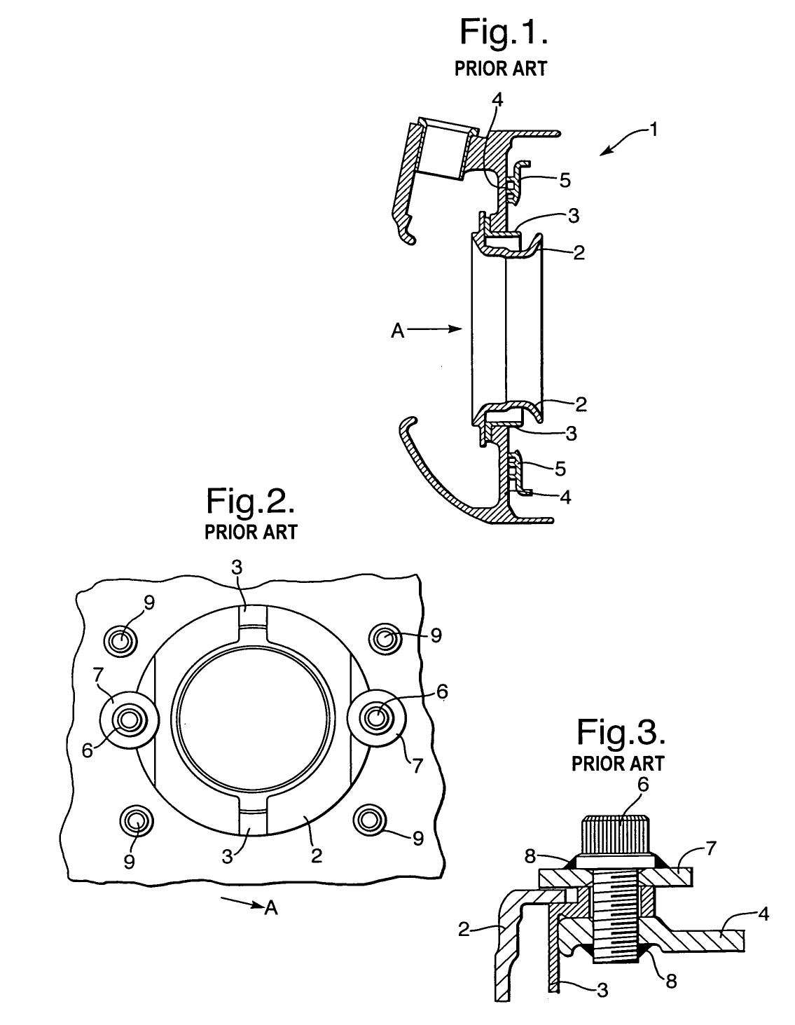

FIG. 1 provides a side cross section illustrating a prior location ring arrangement 1 with a spray nozzle removed. Thus, the arrangement 1 comprises a seal ring 3 within which the spray nozzle will be located. Thus the sealing ring 2 is secured upon a support ring 3 which is then secured to a panel 4 typically referred to in gas turbine engines as a meter panel. This panel 4 is generally an integral part of the engine structure and therefore, as indicated above, requires considerably more effort to be replaced or refurbish than is convenient for routine maintenance and overhaul.

The support ring in addition to presenting the sealing ring 2 and therefore the fuel nozzle also protects the panel 4 from wear in use and therefore ideally the support ring 3 should be more conveniently removable for repair and overhaul. Unfortunately, prior arrangements for locating and securing the sealing ring 2 have involved drilling and tapping the panel 4 at a relatively large number of locations. Furthermore, at each of the locations a welded bolt/washer assembly is utilized to secure the locating ring. As the panel 4 is generally too thin to allow a locking feature to be incorporated within it typically the bolts are locked through a tack weld. It will be appreciated that the sealing ring must be removed before the support ring can be taken from the panel.

It will be understood that inherently with such prior location ring arrangements assembly is relatively costly in terms of expense as well as time in that the bolts must be threaded through each hole in the combustor cowl and arranged in position and secured by welding as indicated. A further detrimental effect is that during repair and overhaul it is necessary to completely remove heat shields 5 to allow access to the tack welds which then require removal by grinding. Again this procedure is time consuming and can result in a number of heat shields being scrapped in use when mounting studs shear off during dis-assembly.

FIG. 2 provides a front view in the direction of arrowhead A of the arrangement 1 depicted in FIG. 1. As can be seen, each support ring 3 and sealing ring 2 is located by a bolt 6 and washer 7. It will be understood that around the circumference of the panel 4 in use generally a number of location ring arrangements 1 with fuel spray nozzles will be provided such that, as indicated, generally forty welds will be required to locate all bolts 6.

FIG. 3 illustrates a cross section of a bolt 6 and washer 7 in accordance with the prior locking arrangement for a location ring depicted in FIGS. 1 and 2, as can be seen, spot welds are provided to lock the bolt 6 in place. In the above circumstances it will be appreciated that the inconvenience and potential problems with regard to overhaul are disadvantageous.

According to the invention there is provided a location ring arrangement for a gas turbine engine, the arrangement comprising a location ring retained as presented to a panel and a heat shield provided on the opposing side of the panel and retained to the panel by a heat shield retainer which retains presentation of both the location ring and the heat shield, characterized in that the heat shield retainer comprises a strap or rail extending between fixing points, the strap or rail overlapping at least part of the location ring.

Preferably a fixing point comprises a bolt or stud. The bolt or stud may be locked by a weld.

Preferably fixing points are arranged in pairs and a strap or rail is provided for each pair of fixing points

Preferably two pairs of fixing points are required and the strap or rails each overlap diametrically opposed parts of the location ring.

According to a further aspect of the invention there is provided a gas turbine engine incorporating a location ring arrangement as claimed in any preceding claim.

Preferably the panel has a plurality of location ring arrangements.

Preferably the location ring presents a fuel spray nozzle within a combustor of the gas turbine engine.

An embodiment of aspects of the present invention will now be described by way of example and with reference to the accompanying drawings in which:—

FIG. 1 provides a side cross section illustrating a prior location ring arrangement;

FIG. 2 provides a front view in the direction of arrowhead A of the arrangement 1 depicted in FIG. 1;

FIG. 3 illustrates a cross section of a bolt 6 and washer 7 in accordance with the prior locking arrangement for a location ring depicted in FIGS. 1 and 2;

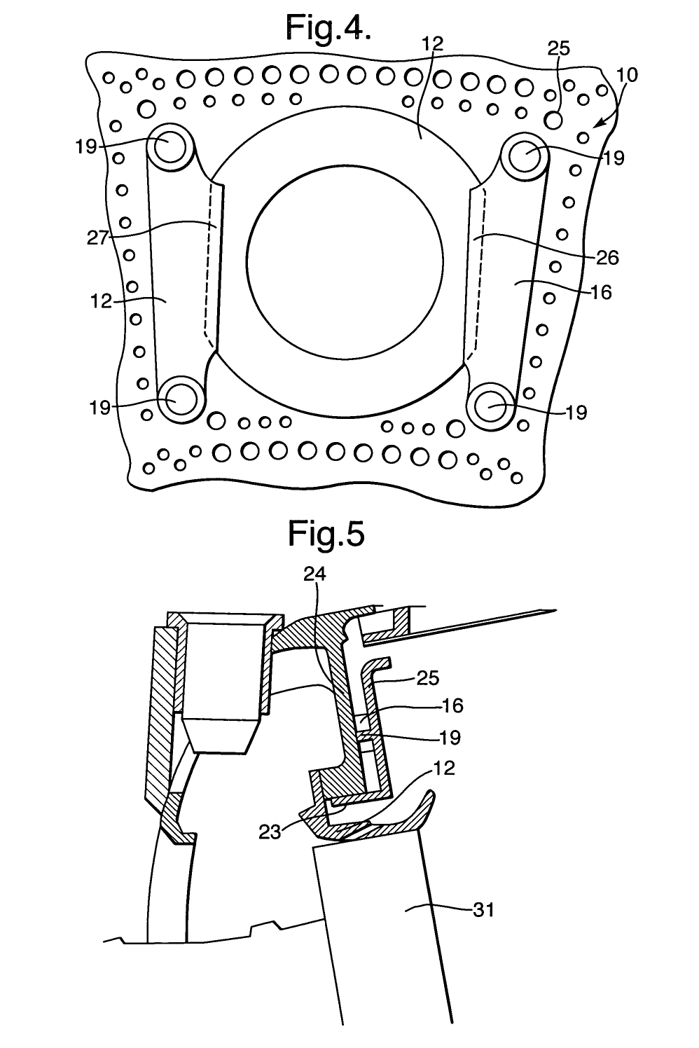

FIG. 4 provides a front view of a location ring arrangement in accordance with aspects of the present invention;

FIG. 5 is a side cross section of a location ring arrangement in accordance with aspects of the present invention; and,

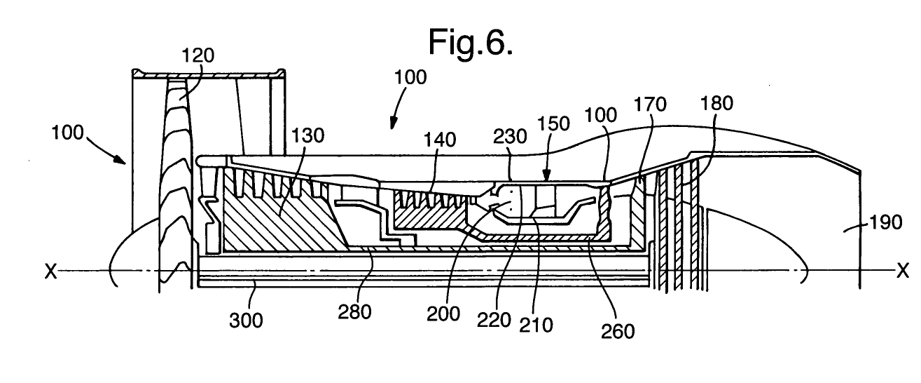

FIG. 6 provides a schematic half cross-section of a gas turbine engine in which a location ring arrangement in accordance with aspects of the present invention may be incorporated.

As indicated above a typical location ring arrangement will also incorporate a heat shield 25 to protect the panel 24 and other mountings of the arrangement in use. This heat shield 25 must be appropriately secured and, as indicated in FIG. 2, generally stud bolts 19 are provided. The stud bolts 19 will secure the heat shield to the panel 24 in use. In accordance with aspects of the present invention the stud bolts 19 act as fixing points and retainers for not only the heat shield 25 but also the support ring 23 in use.

By using the retaining mechanism existing for the heat shield 25 it will be understood that prior bolts 6 and associated washers 7 (FIGS. 1 to 3) as well as drilled and tapped holes for these elements can be removed from an arrangement in accordance with aspects of the present invention in comparison with prior arrangements.

FIG. 4 provides a front view of a location ring arrangement 10 in accordance with aspects of the present invention. Thus, a sealing ring 12 is retained by engagement through retainers 16, 17. These retainers 16, 17 extend between fixing points comprising bolts 19 which extend through the panel and also retain the heat shield (not shown).

The bolts 19 as indicated are normally presented heat shield retainer studs and therefore by providing straps or rails in the form of retainers 16, 17 extending between these studs or fixing points 19 the retainer edges 26, 27 act on one side engaging the sealing ring 12.

FIG. 5 illustrates a cross section through the location ring arrangement of FIG. 4. Thus, the heat shield 25 is retained by fixing points 19 extending through the panel 24. The heat shield 25 is combined with a support ring 23 with the rail or strap 16 presented between studs 19 as depicted in FIG. 4. The combined location ring 10 with heat shield 25 engages the panel 24 such that the sealing ring 12 is engaged by the retainer edges 26, 27 of the retainer straps or rails 16, 17 either side (not shown in FIG. 5) and is held in position with locational reference provided by the engaged portion of the sealing ring 12 about an aperture in the panel 24.

The retainer straps or rails 16, 17 will engage parts 26, 27 of the sealing ring 12 to retain in compression that sealing ring 12 relative to the panel 24.

It will be appreciated that robust positioning and retention of position is achieved by the heat shield retainer studs as fixing points 19 such that the sealing ring 12 portion is equally robustly presented without a requirement, as with previous arrangements, of individually drilled and tapped holes with welded bolts/washer assemblies to secure position. Integrally associating the heat shield 25 with the support ring 23 portion provides a structural integrity such that the combined component has a double functionality that is to say to provide location of the heat shield within the panel 24 as well as a heat shield function. Typically, the bolts utilized for the fixing points 19 again may be spot welded to provide a locking function but it will be understood in order to release these bolts the spot welds associated with the fixing points 19 can be removed by grinding such that the bolts can be removed and therefore the combined heat shield and support ring removed as required.

As indicated previously, generally the support ring will act to preferentially or resist wear in comparison with the panel 24. In such circumstances upon overhaul and repair generally a new heat shield and support ring combination will be installed. By removing the requirement for previous bolts 6 (FIGS. 1 to 3) with associated tapped holes and welds with prior arrangements significant reductions in assembly time and improved life cycle costs may be achieved.

As schematically depicted in FIG. 5 the sealing ring part 12 will accommodate a fuel spray nozzle 31 for presentation into a combustor of a gas turbine engine. FIG. 6 attached shows a typical gas turbine engine configuration in which the combustor is illustrated. For general information operation of the gas turbine engine is in accordance with the following description.

Referring to FIG. 6, a gas turbine engine is generally indicated at 100 and comprises, in axial flow series, an air intake 110, a propulsive fan 120, an intermediate pressure compressor 130, a high pressure compressor 140, combustion equipment 150, a high pressure turbine 160, an intermediate pressure turbine 170, a low pressure turbine 180 and an exhaust nozzle 190.

The gas turbine engine 100 works in a conventional manner so that air entering the intake 110 is accelerated by the fan 120 which produce two air flows: a first air flow into the intermediate pressure compressor 130 and a second air flow which provides propulsive thrust. The intermediate pressure compressor compresses the air flow directed into it before delivering that air to the high pressure compressor 140 where further compression takes place.

The compressed air exhausted from the high pressure compressor 140 is directed into the combustion equipment 150 where it is mixed with fuel and the mixture combusted. The resultant hot combustion products then expand through, and thereby drive, the high, intermediate and low pressure turbines 160, 170 and 180 before being exhausted through the nozzle 190 to provide additional propulsive thrust. The high, intermediate and low pressure turbine 160, 170 and 180 respectively drive the high and intermediate pressure compressors 140 and 130, and the fan 120 by suitable interconnecting shafts.

As can be seen, the gas turbine engine 100 has a combustor 200 positioned where overhaul and repair to gain access to the combustor part of the engine is generally a major operation. By providing in accordance with aspects of the present invention a location ring arrangement in which the heat shield and support ring are combined preferably integrally but at least as a structural combination, which can then be located as a combination by retention means typically utilized for retaining the heat shield alone previously it will be understood that assembly is rendered simpler. Furthermore, by reducing the number of necessary drilled and tapped holes, that is to say holes in which a screw thread is formed to receive a bolt there is less likelihood of failure and a requirement to replace or repair the panel of the combustor 200 itself.

Conventional heat shield retainers are utilized as indicated as fixing points 19 with a strap or rail 16, 17 extending between those points in order that through overlap, particularly with respect to retainer edges 26, 27, there is engagement with a sealing ring 12 upon which the fuel spray nozzles are presented. The structural integration of the support ring 23 with the heat shield components ensure appropriate combination of those elements such that the structural configuration is stable and so the fixing points 19 utilized. It will be understood if the support ring 23 were able to slip forwards unsecured to the heat shield then it would not be able to retain location relative to the panel 24 and therefore through the fixing points 19 and overlap engagement provided by the edges 26, 27 locate the sealing ring 12 appropriately through engagement with the sealing rings edges 30 would not be possible.

Location ring arrangements in accordance with aspects of the present invention will typically be formed from appropriately shaped materials such as nickel based alloys capable of sustaining the desired operational temperatures within a gas turbine engine.

It will be understood that the engagement provided by the retainer edges 26, 27 acts upon the sealing ring 12 in a similar fashion to washers 7 acting upon the sealing ring 2 as depicted in FIG. 2. However, the overlap engagement between the edges 26, 27 will generally be over a broader area in comparison with the washers 7 depicted in FIG. 2. In such circumstances, robust location of the sealing ring should be achieved.

By creating a dual functionality with respect to the combination of the heat shield 25 and retaining ring portion 23, it will be understood, as indicated, that benefits are achieved by reduced numbers of drilled and tapped holes, bolts and other variables within arrangements in accordance with aspects of the present invention. Specific locating or location ring and sealing ring locating bolts (6 in FIGS. 2 and 3) are removed, but the conventional heat shield retaining holes are utilized as fixing points for mountings across which straps or rails as additional components are provided to extend over the sealing ring 12/locating ring positions for achieving a desired structural integrity within a gas turbine engine.

It will be understood that the straps or rails 16, 17 and in particular about the edges 26, 27 should be relatively stiff as they are suspended between the mounting or fixing points 19. It will be understood with prior arrangements the washer engagements 7 were localized about the bolts 6 (FIG. 2) and would provide robust direct engagement. With arrangements 10 in accordance with aspects of the present invention the fixing points 19 are more displaced and therefore depend upon stiffness of the beam essentially provided by the straps or rails 16, 17. In such circumstances the thickness and shaping of the straps or rails 16, 17 will be chosen in order to provide good overlap engagement for retention of assembly configuration.

Modifications and alterations to aspects of the present invention will be understood by those skilled in the art. Thus, for example, it will be noted that the panel provides a number of fuel spray nozzle mountings incorporating location ring arrangements in accordance with aspects of the present invention located in a circle. The retainer straps or rails 16, 17 generally extend along in a radial direction from a central axis of a combustor. However, where required in order to create better location, the retainer combinations may be adjusted such that the overlap provided by the retainer straps or rails is angled rather than radial.

It will also be noted that the retainer straps or rails 16, 17 are generally shaped such that the retainer edges 26, 27 extend across towards each other in a circumferential direction to provide better overlap engagement with the sealing ring 12.

I claim:

1. A location ring arrangement for a gas turbine engine, the arrangement comprising a location ring retained as presented to a panel and a heat shield provided on the opposing side of the panel and retained to the panel by a heat shield retainer which retains presentation of both the location ring and the heat shield, wherein the heat shield retainer comprises a strap or rail extending between fixing points of the heat shield retainer, the strap or rail overlapping at least part of the location ring.

2. An arrangement as claimed in claim 1, wherein a fixing point comprises a bolt or stud.

3. An arrangement as claimed in claim 2, wherein the bolt or stud is locked by a weld.

4. An arrangement as claimed in claim 2, wherein fixing points are arranged in pairs and a strap or rail is provided for each pair of fixing points

5. An arrangement as claimed in claim 4, wherein two pairs of fixing points are required and the strap or rails each overlap diametrically opposed parts of the location ring.

6. A gas turbine engine incorporating a location ring arrangement the arrangement comprising a location ring retained as presented to a panel and a heat shield provided on the opposing side of the panel and retained to the panel by a heat shield retainer which retains presentation of both the location ring and the heat shield, wherein the heat shield retainer comprises a strap or rail extending between fixing points of the heat shield retainer, the strap or rail overlapping at least part of the location ring.

7. A gas turbine engine as claimed in claim 6, wherein a fixing point comprises a bolt or stud.

8. A gas turbine engine as claimed in claim 7, wherein the bolt or stud is locked by a weld.

9. A gas turbine engine as claimed in claim 7, wherein fixing points are arranged in pairs and a strap or rail is provided for each pair of fixing points

10. A gas turbine engine as claimed in claim 9, wherein two pairs of fixing points are required and the strap or rails each overlap diametrically opposed parts of the location ring.

11. An engine as claimed in claim 6, wherein the panel has a plurality of location ring arrangements.

12. An engine as claimed in claim 6, wherein the location ring presents a fuel spray nozzle within a combustor of the gas turbine engine.
